(19) United States
(12) Patent Application Publication
(10) Pub. No.: US 2020/0036259 A1
(43) Pub. Date: Jan. 30, 2020

(54) COOLING JACKET STRUCTURE

(71) Applicant: KSM Castings Group GmbH, Hildesheim (DE)

(72) Inventor: Andreas STRUBE, Schellerten/Wendhausen (DE)

(73) Assignee: KSM Castings Group GmbH, Hildesheim (DE)

(21) Appl. No.: 16/477,285

(22) PCT Filed: Mar. 5, 2018
(86) PCT No.: PCT/DE2018/100192

§ 371 Date: Jul. 11, 2019

(30) Foreign Application Priority Data
Mar. 15, 2017 (DE) 10 2017 105 542.8

(51) Int. Cl. H02K 5/20; H02K 5/18; H02K 9/193

(52) U.S. Cl. CPC H02K 5/20; H02K 5/18; H02K 2213/03; H02K 2207/03; H02K 9/193

(57) ABSTRACT

A cooling jacket structure for cooling a stator of an electric drive, in particular in a motor vehicle, includes a tubular housing, in which a tubular stator carrier is accommodated and fixed in place on the inner side of the housing in such a manner that a gap that extends in the circumferential direction is formed in a section that extends in the axial direction between the inner side of the housing and the outer side of the stator carrier, as a cooling jacket through which a coolant can flow. The inner side of the housing and the outer side of the stator carrier are configured to be conical with reference to their axial direction, at least in the section, and wherein a stator is disposed on the inner side of the stator carrier.

The invention relates to a cooling jacket structure for cooling of a stator of an electric drive, in particular of the electric drive of a motor vehicle.

Electric drives for motor vehicles require efficient cooling of the stator. Almost all of the waste heat of the electric drive occurs in the stator. In order for the temperature in the stator not to exceed, in particular, the limit temperature of the materials used, it is necessary to conduct the heat away. Electric drives of the internal rotor type are known to a person skilled in the art.

The invention is based on the task of making available efficient cooling for the stator of an electric drive of the internal rotor type, in particular of a motor vehicle, which cooling can be implemented in simple manner.

According to the invention, this task is accomplished by means of a cooling jacket structure having the characteristics of claim 1. Preferred or advantageous embodiments of the invention are evident from the dependent claims, the following description, and the attached figures.

The cooling jacket structure according to the invention, for cooling of a stator of an electric drive, in particular of the electric drive of a motor vehicle, comprises a tubular housing, in which a tubular stator carrier is accommodated and fixed in place on the inner side of the housing in such a manner that a gap that extends in the circumferential direction is formed in a section that extends in the axial direction between the inner side of the housing and the outer side of the stator carrier, as a cooling jacket through which a coolant can flow, wherein the inner side of the housing and the outer side of the stator carrier are configured to be conical with reference to their axial direction, at least in the section, and wherein a stator is disposed on the inner side of the stator carrier.

The cooling jacket structure according to the invention can be implemented in particularly simple manner. The at least partially conical structure of the inner side of the housing and of the outer side of the stator carrier allows particularly simple joining of housing and stator carrier, as well as formation of a cooling jacket that ensures efficient cooling of the stator.

In the aforementioned section, the inner side of the housing and the outer side of the stator carrier each form a jacket surface. It can be advantageous if the angle ϕ, namely the angle present between a jacket line of the respective jacket and the longitudinal axis or center axis of the housing or of the stator amounts to between 1° and 5°, preferably between 1° and 3°.

For improved cooling, it can be advantageous if the stator carrier has circumferential cooling ribs on its outer side, in other words ribs projecting into the gap. These are distributed over the section, preferably uniformly. The gap dimension of the cooling jacket is preferably dimensioned in such a manner that optimal cooling is achieved.

It can be advantageous if the cooling ribs are connected with one another in such a manner that they wind around the outer side of the stator carrier over the aforementioned section, in helical shape, like a single cooling rib, so that a cooling channel in the manner of a spiral is formed. In this regard, it has been shown that the cooling ribs or the single helical cooling rib do not or does not have to connect with the inner side of the housing, since a cooling medium that flows through the cooling channel, for example water, goes through the cooling channel along the path of least resistance, in other words does not pass through a gap present between the cooling rib and the inner side of the housing, or does not do so to a noteworthy extent. Therefore the cooling effect is not negatively influenced.

It can be advantageous if the stator carrier is configured to be cylindrical on its inner side, in particular in the region connected with the stator. As a result, the stator can be oriented optimally with regard to a rotor.

It can be advantageous if the outer side of the housing is configured to be at least partially conical in the axial direction. In this way, a uniform wall thickness is obtained in the region of the section, which thickness is advantageously accompanied by a saving in weight.

It can be advantageous if the housing is preferably cast in one piece, preferably die-cast. In this regard, the conical structure according to the invention can also have an advantageous effect on the castability and unmoldability of the housing.

It can be advantageous if the stator, preferably with the cooling ribs or with the helical cooling rib, is preferably cast in one piece, preferably die-cast. In this regard, the conical structure according to the invention can have an advantageous effect on the castability and unmoldability of the stator carrier. The one-piece structure has an advantageous effect on the conduction of the heat given off by the stator into the cooling jacket.

It can be advantageous if the housing and/or the stator carrier consist/consists of a light metal, preferably of an aluminum alloy. It is advantageous that the latter has great heat conductivity.

It can be advantageous if the inner side of the housing and/or the outer side of the stator carrier is/are non-worked in the region of the section. As a result, for one thing the work effort for forming the cooling jacket is significantly reduced, wherein the non-worked region represents an optimal sealing surface to prevent exit of the coolant. For another thing, however, the non-worked region can also have an influence on the coolant flow and can advantageously increase the cooling effect.

With regard to efficient cooling of the stator and a structure of the cooling jacket that is particularly easy to implement, it is advantageous if the cooling jacket is configured in the form of a hollow truncated cone.

It can be advantageous if the stator carrier has two contact surfaces that are spaced apart from one another in the axial direction and are oriented in the axial direction, which surfaces lie against corresponding contact surfaces of the inner side of the housing and fix the stator carrier in place in the axial direction. In this way, easy insertion of the stator into the housing and joining of the stator with the housing are ensured.

It can be advantageous if the stator carrier has two fixation surfaces that are spaced apart from one another in the axial direction and are oriented in the radial direction, which surfaces lie against the inner side of the housing in the radial direction. The structure of these fixation surfaces or of the counter-pieces on the inner side of the housing establish the structure of the gap or of the cooling jacket, in particular also the gap dimension.

It can be advantageous if each fixation surface has an O-ring assigned to it, which fixes the stator carrier in place in the radial direction and, in particular, seals it off. The O-rings are preferably situated in grooves formed in the stator carrier. It has been shown that because of the aforementioned conical structure of the inner side of the housing, the O-rings do not tend to grind against the inner wall of the housing, to roll up, and to jump out of the groove, in disadvantageous manner, during introduction of the stator carrier into the housing, as would be the case for a cylindrical structure of the inner side of the housing. According to the invention, an optimal seat of the O-rings is thereby ensured, due to the aforementioned conical structure.

Further details and advantageous embodiments of the invention are evident from the following description in combination with the drawing. In this drawing,

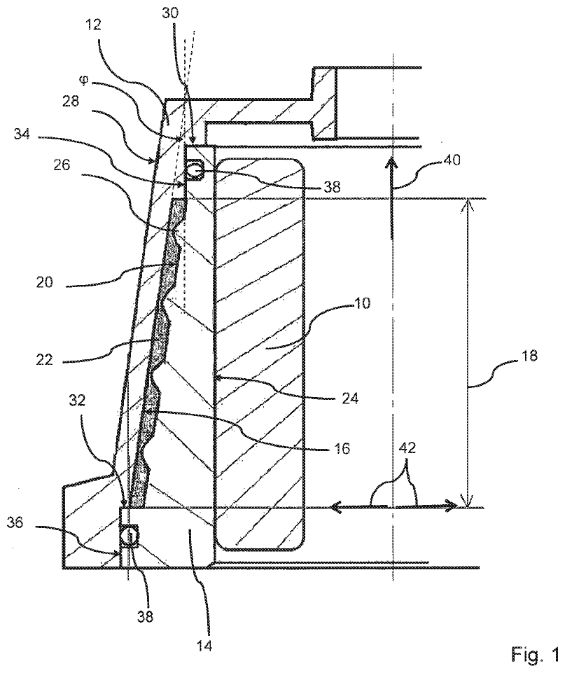

FIG. 1 shows, in a detail, a schematic longitudinal section of an electric drive of the internal rotor type, having a stator, which is fixed in place on a housing of the electric drive by way of a stator carrier, with the formation of a cooling jacket.

The cooling jacket structure for cooling of the stator 10 of an electric drive, shown here incompletely, in other words only in details and schematically, in longitudinal section, in particular of a motor vehicle, comprises a tubular housing 12, in which a tubular stator carrier 14 is accommodated and fixed in place on the inner side 16 of the housing 12, in such a manner that a gap 22 that extends in the circumferential direction is formed in a section 18 that extends in the axial direction 40 between the inner side 16 of the housing 12 and the outer side 20 of the stator carrier 14, as a cooling jacket 22 through which a coolant can flow, wherein the inner side 16 of the housing 12 and the outer side 20 of the stator carrier 14 are configured to be conical with reference to their axial direction 40, at least in the section 18, and wherein a stator 10 is disposed on the inner side 24 of the stator carrier 14.

The heat is conducted into the cooling jacket 22 by the stator 10, by way of the stator carrier 14. The cooling jacket 22 preferably has a coolant, in particular a cooling liquid, flowing through it.

In the aforementioned section 18, the inner side 16 of the housing 12 and the outer side 20 of the stator carrier 14 each form a jacket surface. The angle ϕ between a jacket line of the respective jacket and the longitudinal axis or center axis of the housing or of the stator carrier amounts to between 1° and 5°, preferably between 1° and 3°.

The stator carrier 14 has cooling ribs 26 that run circumferentially on its outer side 20, which ribs are disposed distributed over the section 18. The cooling ribs 26 are connected with one another in such a manner that they wind around the outer side 20 of the stator carrier 14 over the aforementioned section 18, in helical shape, like a single cooling rib 26, so that a cooling channel in the manner of a spiral is formed, through which a cooling medium, for example water, flows. In this regard, the cooling medium flows through the cooling channel by way of an inlet at one end and leaves the cooling channel again through an outlet at the other end of the cooling channel.

Corresponding connectors, not shown here, for the inlet and outlet of the coolant, are provided in the housing, i.e. on the outer side of the housing.

The stator carrier 14 is configured to be cylindrical on its inner side 24, in the region connected with the stator 10.

The outer side 28 of the housing 12 is configured to be conical in the axial direction, at least in part.

The cooling jacket 22 according to the invention is configured in the form of a hollow truncated cone.

The stator carrier 14 has two contact surfaces 30, 32 that are spaced apart from one another in the axial direction 40 and are oriented in the axial direction 40, which surfaces lie against corresponding contact surfaces of the inner side 16 of the housing 12 and fix the stator carrier 14 in place in the axial direction 40.

Furthermore, the stator carrier 14 has two fixation surfaces 34, 36 that are spaced apart from one another in the axial direction 40 and are oriented in the radial direction 42, which surfaces lie against the inner side 16 of the housing 12 in the radial direction 42. Each fixation surface 34, 36 has an O-ring 38 assigned to it, which fixes the stator carrier 14 in place in the radial direction 42 and, in particular, seals it off. Alternatively or in addition, the stator carrier 14 can also be connected with the housing 12 and sealed by means of other types of attachment, for example by means of gluing and welding.

### REFERENCE SYMBOL LIST

### (Is Part of the Description)

10 stator
12 housing
14 stator carrier
16 inner side
18 section
20 outer side
22 gap
24 inner side
26 cooling rib
28 outer side
30 contact surface
32 contact surface
34 fixation surface
36 fixation surface
38 O-ring
40 axial direction
42 radial direction
ϕ half the opening angle

1. A cooling jacket structure for cooling of a stator (10) of an electric drive, in particular of the electric drive of a motor vehicle, comprising a tubular housing (12), in which a tubular stator carrier (14) is accommodated and fixed in place on the inner side (16) of the housing (12) in such a manner that a gap (22) that extends in the circumferential direction is formed in a section (18) that extends in the axial direction between the inner side (16) of the housing (12) and the outer side (20) of the stator carrier (14), as a cooling jacket (22) through which a coolant can flow, wherein the inner side (16) of the housing (12) and the outer side (20) of the stator carrier (14) are configured to be conical with reference to their axial direction, at least in the section (18), and wherein a stator (10) is disposed on the inner side (24) of the stator carrier (14).

2. The cooling jacket structure according to claim 1, wherein the stator carrier (14) has circumferential cooling ribs (26) on its outer side (20), which ribs are distributed over the section (18), preferably uniformly.

3. The cooling jacket structure according to claim 1, wherein the cooling ribs (26) are connected with one another in such a manner that they wind around the outer side (20) of the stator carrier (14) over the section (18), in helical shape, like a single cooling rib (26), so that a cooling channel in the manner of a spiral is formed over the section (18).

4. The cooling jacket structure according to claim 1, wherein the stator carrier (14) is configured to be cylindrical on its inner side (24), in particular in the region connected with the stator (10).

5. The cooling jacket structure according to claim 1, wherein the outer side (28) of the housing (12) is configured to be at least partially conical in the axial direction.

6. The cooling jacket structure according to claim 1, wherein the housing (12) is cast in one piece.

7. The cooling jacket structure according to claim 1, wherein the stator carrier (14) is cast in one piece.

8. The cooling jacket structure according to claim 1, wherein at least one of the housing (12) and the stator carrier (14) comprises a light metal, preferably of an aluminum alloy.

9. The cooling jacket structure according to claim 1, wherein at least one of the inner side (18) of the housing and the outer side (20) of the stator carrier is non-worked in the region of the section (18).

10. The cooling jacket structure according to claim 1, wherein the cooling jacket (22) is configured in the form of a hollow truncated cone.

11. The cooling jacket structure according to claim 1, wherein half the opening angle (ϕ) of the cooling jacket (22) in the form of a hollow truncated cone amounts to between 1° and 5°, preferably between 1° and 3°.

12. The cooling jacket structure according to claim 1, wherein the stator carrier (14) has two contact surfaces (30, 32) that are spaced apart from one another in the axial direction and are oriented in the axial direction, which surfaces lie against corresponding contact surfaces of the inner side (16) of the housing (12) and fix the stator carrier (14) in place in the axial direction.

13. The cooling jacket structure according to claim 1, wherein the stator carrier (14) has two fixation surfaces (34, 36) that are spaced apart from one another in the axial direction and are oriented in the radial direction, which surfaces lie against the inner side (16) of the housing (12) in the radial direction.

14. The cooling jacket structure according to claim 11, wherein each fixation surface (34, 36) has an O-ring (40) assigned to it, which fixes the stator carrier (14) in place in the radial direction and/or seals it off.
